(19) United States
(12) Patent Application Publication
(10) Pub. No.: US 2004/0046109 A1
(43) Pub. Date: Mar. 11, 2004

(54) Method and apparatus for high speed interrogation of fiber optic detector arrays

(76) Inventors: Peter C. Chen, Clarksville, MD (US); Jason S. Kiddy, Glenn Dale, MD (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/234,120

(22) Filed: Sep. 5, 2002

(51) Int. Cl. G01J 1/04; G01J 5/08

(52) U.S. Cl. 250/227.14

(57) ABSTRACT

The invention provides a method of sampling M sensors in a fiber optic detector array, by determining a maximum sampling rate possible, and assigning priority to each sensor. Thereafter, available sampling spots are divided into discrete blocks and the sensor of highest priority is assigned sampling slot(s). The remaining sensors are placed in the remaining sampling slots in order of priority, and if a sampling slot is taken, the remaining sensors are placed in the next closest slot. The invention also provides 1D and 2D digital and spatial wavelength domain systems including a plurality of fiber Bragg gratings (FBGs). The FBGs may be illuminated by a plurality of broad band light sources, and coupled thereto by 2×2 couplers. The systems may include a 1D or 2D wavelength dispersion device, and 1D or 2D optically sensitive solid state means for spatially separating the signals at each wavelength reflected by the FBGs.

### BACKGROUND OF INVENTION

a. Field of Invention

The invention relates generally to a method and apparatus for multiplexing signals, and more particularly, to a method and apparatus for de-multiplexing optical signals in the spatial and wavelength domains, employing a dispersion device optically coupled to a random access imager, and employing software for sub-pixel interpolation.

b. Description of Related Art

Optical fiber sensor systems employ multiplexing techniques to allow the sharing of a source and processing electronics to reduce the per sensor cost and thereby improve the competitiveness of such systems. Such optical fiber systems are disclosed in co-pending U.S. application Ser. No. 09/463,008, Attorney Docket No. 066261-0006, titled “Large Scale High Speed Multiplexed Optical Fiber Sensor Network,” the subject matter of which is incorporated herein by reference. Component sharing helps to reduce the overall weight of the system and enhances robustness. A variety of multiplexing technologies are known including spatial, wavelength, frequency and coherence domain multiplexing. However, the multiplexing capacity of any of these techniques is generally limited to about ten sensors due to various factors including speed, cross talk, signal to noise ratio and wavelength bandwidth. Some systems employ two or more techniques to increase multiplexing capacity. In particular, spatial domain multiplexing is advantageously combined with other techniques, generally because it does not degrade system performance.

Fiber optic Bragg gratings (FBG) have become one of the most successful of the optical fiber sensors available. These devices are generally compact, have absolute wavelength encoding, and have the potential for mass production. Sensor signals may be wavelength encoded rather than intensity encoded. Thus the sensed signal is independent of power variations in the light source and system losses. Additionally, an array of FBG sensors can be readily made by connecting several FBGs having different center wavelengths in a line along a length of fiber. Each FBG may be individually addressed using wavelength multiplexing in the wavelength domain. Conventional systems using FBGs have thus far had limited capacity in the number of fibers and FBGs per fiber, which has been limited by the bandwidth and intensity of the broadband source.

Conventional spatial multiplexing locates sensors into many fiber channels and may employ a separate electronic signal processing unit for each channel. Certain applications such as monitoring aerospace structures or process control and massive data collection require higher multiplexing capacity, and high accuracy in the sensed signal. Thus far, conventional data acquisition methods have had an inadequate multiplexing capacity for such high speed applications. Moreover, in today's high speed systems, there is an ongoing need for greater accuracy in interpolation of sensed signal.

### SUMMARY OF INVENTION

The present invention seeks to overcome and obviate the disadvantages and limitations of the described prior arrangements.

Thus an aspect of the invention is to provide a fiber optic detector array using FBGs, which is not limited in capacity to a maximum number of fibers and FBGs per fiber, based upon the bandwidth and intensity of the broadband source.

Another aspect of the invention is to provide a fiber optic detector array using FBGs, with an improved method of analyzing and prioritizing the sensed signals from the fibers and/or the FBG sensors per fiber.

Yet another aspect of the invention is to provide an improved method of interpolating a sensed signal.

The invention accomplishes these aspects by providing a method of sampling M sensors in a fiber optic system. The method includes the steps of determining a maximum sampling rate possible, thereby defining N samples per time period, and assigning priority from X₁ to X_{M} for each sensor, such that a sensor of highest priority is assigned priority X₁ and a sensor of lowest priority is assigned priority X_{M}. The method further includes the steps of dividing available sampling spots into discrete blocks, thereby defining N discrete blocks per time period, and assigning at least one available sampling slot to a sensor Y(1) of highest priority X₁, and placing sensor Y(1) in at least one available sampling slot. The method yet further includes the steps of assigning at least one other available sampling slot to sensors Y(2) to Y(M) of second priority X₂ to lowest priority X_{M}, respectively, and placing sensor Y(2) in a closest available sampling slot if the sampling slot for sensor Y(2) is already filled. The method finally includes the steps of repeating the placing step in order from sensor Y(3) to sensor Y(M) until all sampling slots are filled, and sampling the M sensors in order of the assigned sampling slots.

For the method of sampling M sensors in a fiber optic system, the closest available slot is a slot one-back of the filled spot. If the closest available slot is taken, the closest available slot is a slot one-forward of the filled spot such that the closest available slot is determined by toggling back and forth in increasing steps until a closest available slot is free, the closest available slot being the free slot. In the method of sampling M sensors in a fiber optic system, the time period may be seconds. The sensors may be defined as fibers including multiple fiber Bragg grating. Alternatively, the sensor may be defined as a fiber Bragg grating.

The invention also provides a digital spatial and wavelength domain system for multiplexing fiber Bragg grating (FBG) sensors. The system includes a plurality of optical fibers, each including a plurality of FBGs therein. Each FBG has a selective center wavelength, which is variable in accordance with strain for reflecting or transmitting light at the corresponding center wavelength in accordance with the strain thereat. A plurality of broad band light illumination sources for the FBGs may be provided, with each source being coupled to the FBGs by a plurality of 2×2 couplers. The system further includes means for each optical fiber for carrying the light to a selected location, and a wavelength dispersion device responsive to the light from each of the fibers for wavelength separating the light in each fiber into the center wavelengths in accordance with the location of each fiber so that the selected location of each fiber and the wavelength separated light provides spatially independent signals for each FBG in each optical fiber.

In the digital spatial and wavelength domain system described above, each 2×2 coupler includes first and second input arms, and first and second output arms. The first input arm of a 2×2 coupler may be connected to the source(s), to the first or second output arms of another 2×2 coupler, or blocked. The second input arm of the 2×2 coupler may be connected to another source(s), to the first or second output arms of another 2×2 coupler, or blocked. The first output arm of the 2×2 coupler may be connected to an input arm of another 2×2 coupler, or an optical fiber. The second output arm of the 2×2 coupler may be connected to an input arm of another 2×2 coupler, or an optical fiber. This connection method for the 2×2 couplers permits maximum usage of light from the light source(s) by feeding back light from an open output arm of a 2×2 coupler to an open input arm of a 2×2 coupler.

The invention yet further provides a digital and spatial wavelength domain system. The system may include a plurality of optical fibers, each including a plurality of fiber Bragg gratings (FBGs), each having a center wavelength. A plurality of broad band light sources may be provided for illuminating each FBG, with each source being coupled to the FBGs by a plurality of 2×2 couplers (as described above). Each of the FBGs may be operative for reflecting a portion of the light at the center wavelength corresponding thereto in accordance with a stress applied to the fiber thereat. The system may further include a wavelength dispersion device operatively coupled to each fiber and responsive to the light for separating the light in each fiber into a sensible signal at the corresponding wavelength for each FBG. An optically sensitive solid state means spatially responsive to the sensible signal for producing an output for spatially separating the signals at each wavelength, may also be provided.

In the digital and spatial wavelength domain system described above, the wavelength dispersion device may include a bulk grating. The grating may include a mirror lens having a focal plane and a grating disposed on a reflective surface thereof. The grating may also include parallel grooves formed in the reflective surface. The system may further include fiber means for carrying the light from the fiber to a wavelength dispersion device, the fiber means having output ends aligned in a linear array. The optically sensitive means may include a solid state sensing device including a plurality of pixels arranged in a two dimensional array, with the pixels being randomly accessible. The imaging device may include a 2D array of pixels. The wavelength separated light may impinge on the array at selected pixel locations. The light from the impinging light may form a spot on the imaging device covering a plurality of pixels and further include processing means for sensing the light in each of the pixels. The light may be weight averaged for determining a centroid of the spot corresponding to the center wavelength thereof. The system may further include a plurality of strain independent sensor means for each fiber for providing a temperature calibration signal at a selected center wavelength. The strain independent sensor means may be disposed at the free end of the fiber remote from the source, or may be disposed within the fiber. The system may further include means for detecting the center wavelength for each wavelength separated signal in accordance with centroid weighting, curve fitting, or linear and higher order interpolation. Means for carrying the light to the wavelength dispersion device may be provided. The means may include a down-lead fiber for each optical fiber, and a free end of the optical fibers. The system may yet further include means for distributing the light to each optical fiber.

For the digital and spatial wavelength domain system described above, the centroid may be determined by a circuit for determining intensity values of said signal over a range of sensed wavelengths and a circuit for subtracting a threshold value from said intensity values, thereby defining negative and positive intensity values. The centroid may further be determined by a circuit for setting said negative intensity values to zero and a circuit for interpolating said centroid by taking a weighted average of said positive intensity values.

The invention yet further provides a method of determining the centroid in the digital and spatial wavelength domain system described above. The method may include the steps of determining intensity values of the signal over a range of sensed wavelengths and subtracting a threshold value from the intensity values, thereby defining negative and positive intensity values. The method may further include the steps of setting the negative intensity values to zero and interpolating the centroid by taking a weighted average of the positive intensity values.

The invention yet further provides a digital and spatial wavelength domain system. The system may include a single optical fiber including a plurality of fiber Bragg gratings (FBGs), each having a center wavelength. A plurality of broad band light sources for illuminating each FBG may be provided. Each FBG may be operative for reflecting a portion of the light at the center wavelength corresponding thereto in accordance with a stress applied to the fiber thereat. A wavelength dispersion device may be operatively coupled to the fiber and responsive to the light for separating the light in the fiber into a sensible signal at the corresponding wavelength for each FBG. The system may include optically sensitive solid state means spatially responsive to the sensible signal for producing an output for spatially separating the signals at each wavelength. The system may also include all the features described above for the digital and spatial wavelength domain system, which includes multiple fibers.

In the digital and spatial wavelength domain system described above, the wavelength dispersion device may be a one-dimensional device and the optically sensitive means may include a one-dimensional solid state sensing device.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a generalized illustration of a wavelength and spatial domain multiplexing device according to the present invention;

FIG. 1A is a detail of a 1 D fiber output array;

FIG. 1B is a schematic illustration of a random access image sensor and driver;

FIG. 1C is a fragmenting illustration of a portion of the image sensor illustrating the output spot and pixels;

FIG. 1D is a plot illustrating a weighted algorithm in linear and logarithmic form;

FIG. 1E is a generalized illustration of the operation of a fiber Bragg grating;

FIG. 2 is a more specific illustration of an apparatus for achieving spatial and wavelength domain multiplexing in accordance with the present invention;

FIGS. 3A-3C are diagrams illustrating an ordering cycle algorithm for evaluating channels and/or sensors, based on channel/sensor priority, according to the present invention;

FIGS. 4A-4C are diagrams illustrating a method of eliminating background noise according to the present invention;

FIG. 5 is a diagram illustrating a setup for sending light from a source to multiple fiber Bragg gratings and back to an interrogation system, by 2×2 couplers, according to the present invention;

FIG. 6 is a diagram illustrating a setup for sending light from a source to multiple fiber Bragg gratings and back to an interrogation system, by 2×2 couplers, and for recapturing light which would normally be lost, according to the present invention; and

FIG. 7 is an illustration of a one-dimensional apparatus for achieving spatial and wavelength domain multiplexing in accordance with the present invention.

### DETAILED DESCRIPTION OF THE PREFERRED EMBODIMENT(S)

The present invention includes both software and hardware components. For the sake of clarity, these components will be described separately. It should however be understood that these components are not exclusive of each other, and may be used in conjunction with or separately from each other. Moreover, the software and hardware components for the present invention may be utilized in a one-dimensional (1D) or a two-dimensional (2D) setup, as explained in greater detail below.

Before describing the fiber optic array setup of the present invention and the method and apparatus for analyzing signals reflected therefrom, properties of fiber Bragg grating (FBG) sensors, which are used to reflect light in the fibers, will first be described in detail.

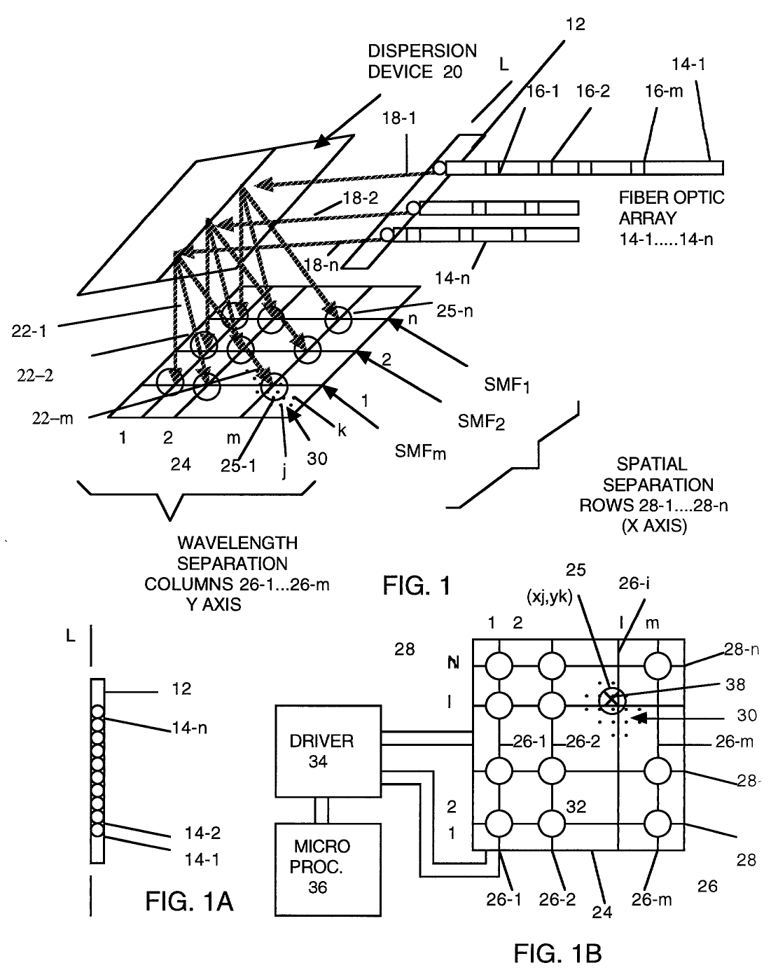

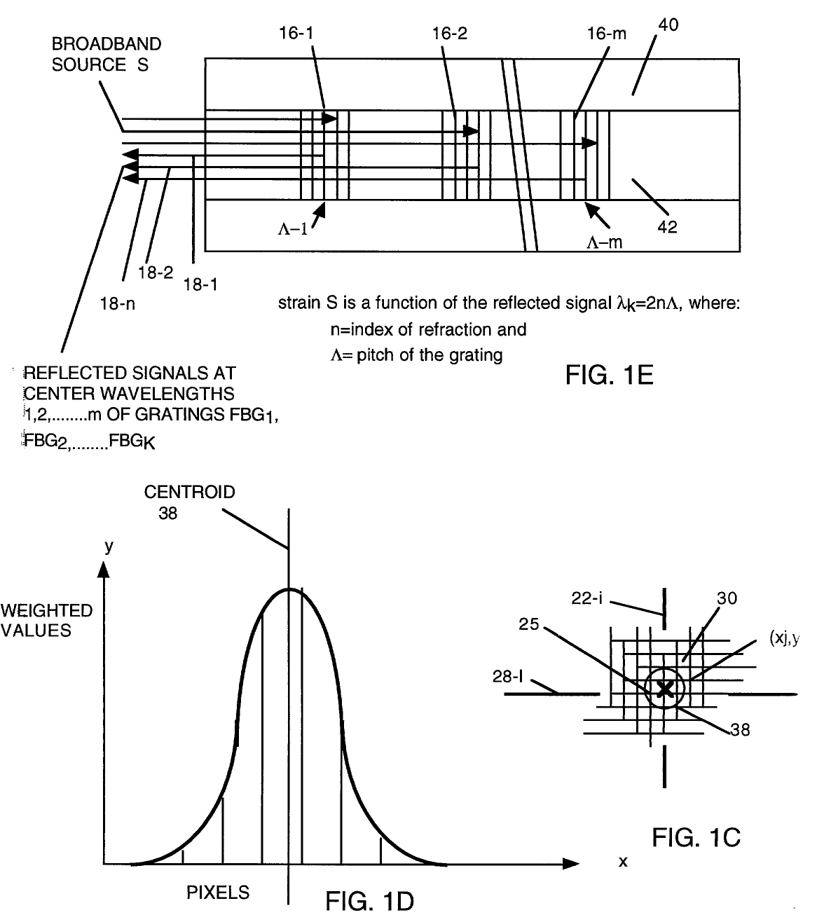

FIG. 1 generally illustrates a 2D fiber optic array 12 of channels 14-1 . . . 14-n having a plurality of FBG sensors 16-1 . . . 16-m, which produce outputs 18-1 . . . 18-n. Such FBG sensors may be fabricated using holographic or phase mask techniques to expose a germanium doped (and sometimes boron co-doped) optical fiber to a periodic intensity distribution. These fibers are photosensitive, which means that their refractive indices change upon exposure to UV light. Because of this photosensitivity, the impinging sinusoidal intensity distribution results in a sinusoidal refractive index distribution in the fiber core. The combined effect of the periodic index distribution is to reflect light at a very specific wavelength known as the “Bragg wavelength”. This wavelength is predictable in terms of the mean refractive index, η, and the pitch of the periodicity, Λ, by λ_{B}=2ηΛ. Sensors may be made from these gratings by taking advantage of the fact that the grating pitch and refractive index are both functionally dependent on strain and temperature.

Accordingly, strain or temperature on the grating causes the Bragg wavelength to shift left or right. The wavelength encoded nature of FBG sensors offers the greatest potential for multiplexing in wavelength domain along a single length of optical fiber. Multiplexing may be accomplished by producing an optical fiber, such as channels 14-1 . . . 14-n shown in FIG. 1, with a sequence of spatially separated Bragg gratings, each having a different pitch, Λₖ, k=1, 2, 3, . . . n. The resulting Bragg wave-lengths associated with each pitch may therefore given by λ_{Bk}=2ηΛₖ, k=1, 2, 3, . . . n. Because the unstrained Bragg wavelength of each FBG is different, the information from each sensor is individually determined by examining the wavelength spectrum. For example, where a strain field at grating 16-2 is uniquely encoded as a perturbation to Bragg wavelength Λ2. The Bragg wavelengths associated with the other gratings remain unchanged.

FBGs are the natural sensor of tensile strain when they are attached on or embedded in the host material. However, FBGs can be adapted to detect a wide range of other physical parameters by converting the change of the relevant parameter into strain. For example, FBGs can be used to measure humidity by coating the FBG with a layer of hydrogel, which expands upon water absorption thus converting humidity into strain. Similarly, a FBG can become a hydrogen sensor by coating it with a layer of Pallandium, which expands after absorbing hydrogen. The use of FBGs for pressure sensing can be achieved where gratings are written into fibers with side cavities. This fiber structure converts side pressure into axial strain at the core of the fiber. Because both the grating pitch,Λ and refractive index, η change with the temperature, the Bragg wavelength of a FBG shifts with the temperature by approximately 1.7 pm/° C., which makes a FBG a temperature sensor. FBG sensors may also be used to measure other parameters such as acceleration, displacement, vibration and force, for example.

Two-Dimensional Fiber Optic Array Setup

A 2D fiber optic array setup according to the present invention using the FBG sensors described above will next be described in detail.

As described above, FIG. 1 generally illustrates the operative principle of the present invention in which the 2D fiber optic array 12 of channels 14-1 . . . 14-n having a plurality of FBG sensors 16-1 . . . 16-m produce outputs 18-1 . . . 18-n. The light in each output is a signal containing a plurality of discrete wavelengths centered at selected wavelengths corresponding to the center wavelengths of the respective FBG sensors 16-1 . . . 16-m. The fiber optic channels 14-1 . . . 14-n may be disposed side by side and spatially separated along a line L as shown in FIG. 1A. Likewise, the spatially separated light outputs 18-1 . . . 18-n may be directed at the dispersion device 20 which separates each signal into a plurality of corresponding wavelength separated signals 22-1 . . . 22-m for each fiber, which signals are directed towards 2D image sensor 24 and which form spots 25-1 . . . 25-n thereon. Dispersion device 20 may be a conventional spectrometer.

The wavelength of the various components making up the light 18-1 . . . 18-n represents a measured parameter. For example, FIG. 1E shows a broad band source S coupled to an optical fiber 40 having m fiber Bragg gratings 16-1 . . . 16-m. Each Bragg gratings 16 has a corresponding pitch Λ-1 . . . Λ-m developed as a change in the refractive index of the core 42. The pitch is related to a corresponding center wavelength λ-1 . . . λ-m and is proportional to the pitch Λ-1 . . . Λ-m respectively. As the strain on the FBG 16-1 . . . 16-m changes, the pitch Λ-1 . . . Λ-m likewise changes causing the center wavelength of the corresponding light outputs 18-1 . . . 18-n to change accordingly. A change in the wavelength is reflected as a slight shift in the position of the spot in the sensor corresponding to the change in the pitch of the FBG. If a plurality of FBGs 16-1 . . . 16-m are formed in the core 42 of the fiber 40, multiple parameters may be sensed using the same fiber to carry a plurality of signals. The problem, of course, as noted above, is to separate the various reflected signals 22-1 . . . 22-n using the multiplexing techniques of the present invention. As the wavelength changes, the dispersion device 20 causes a shift in the column position of the wavelength separated signal which corresponds to an indication of increasing or decreasing strain. For each of the spots 25-1 . . . 25-m in each row 28-1 . . . 28-n on the sensor 24, a unique strain measurement may thus be obtained.

The sensor 24 may be a 2D image sensor 24 having k columns 26 and j rows 28 of pixels formed therein where k & j are much larger than m & n so that a spot 25 falls on a cluster of pixels 30. As can be seen in FIG. 1B, the wavelength separated spots 25-1 . . . 25-n in each channel fall more or less into the various columns 26-1 . . . 26-m of the image sensor 24 and cover a cluster of pixels 30 along a row 28-1 corresponding to the location of the first fiber optic channel 14-1 in the array 12. Likewise, the rows 28-2 . . . 28-n correspond to the position of the respective fiber optic channels 14-2 . . . 14-n respectively. The columns 26 represent wavelengths. For example, the signal 18-1 may be broken up into wavelengths 22-1 . . . 22-m corresponding to the number of FBG and form spots near the columns 26-1 . . . 26-m covering clusters of pixels 30 therein as shown. Each unique pixel coordinate (xj, yk) on the sensor 24 may provide information about the corresponding signal carried by the fiber optic array 12 the weighted center of the light falling on the pixels 30 under each spot 25 is a member of its wavelength and thus provides a strain measurement.

In the exemplary embodiment of the invention shown in FIGS. 1, 1B, & 1C the sensor 24 may be a randomly accessible device such as a complementary metal-oxide semiconductor (CMOS) image sensors, which allows any selected pixel 30 (xj, yk) or a cluster of pixels to be randomly addressed and read out as opposed to a system which requires sequential scanning of each pixel on the entire imager. Since CMOS image sensors can randomly access information at a specific pixel individually, this capability makes them ideal for some special applications such as missile tracking, where the area of interest is only a small portion of the image and the event is too fast to wait the entire image to be read out.

As shown in FIGS. 1B & 1C, light signals 22-1 . . . 22-m appear as spots 25 on the image sensor 24 covering more or less pixel clusters 30, along rows and columns as shown. A driver device 34 which may be suitably driven by a programmed computer or microprocessor 36 selectively reads data from the x, y coordinates of the sensor by selectively addressing the pixel cluster 30 located at or near the spot locations. Information as to the position of spot 25 relative to each of the corresponding proximate pixel clusters 30 may be processed to determine the precise central location or centroid 38 at (xj,yk) of spot 25 in the pixel array. The location of the spot 25 may be accurately determined by sub-pixel interpolation. In an exemplary embodiment, the centroid 38 shown as a cross in FIGS. 1B & 1C, is the weighted average of the illuminated pixels under spot 25.

The centroid 38 must be measured precisely for applications such as target tracking applications, which require measurement of the precise position of a point object on an image sensor. As shown in FIGS. 1C & 1D, the intensity profile of such a point object normally spreads over a cluster of pixels on the imager. There are a number of interpolation algorithms available, which make use of this intensity distribution to calculate the center of the profile to sub-pixel precision. Among them, the centroid algorithm is the most mature and versatile method, because it simply calculates the “weight center” of the profile, thus does not have to know the shape of the profile in advance. The algorithm may be used even for asymmetric profiles. Using a 2D centroid method, the precise position of the object along X coordinate (pixel rows), x_{c}, is calculated as:

x_{c}=Σₗi(Σⱼg_{y})/ΣₗΣⱼg_{y}

where i, j is the column and row number of a particular pixel in the imager, g is the gray scale, i.e. pixel output at this pixel and all the sum are within the cluster boundary.

The precision of this algorithm depends on the stability and shape of the intensity profile, the size of the pixel cluster used for calculation and the pixel noise and uniformity of the imager. Generally a larger spot yields a better resolution because of the averaging effect. However, study has shown that interpolation resolution no longer improves when the spot becomes larger than a particular cluster size, which is termed the “optimum cluster size”. Naturally, the higher the imager quality (in terms of pixel noise and uniformity), the smaller the optimum cluster size.

A smaller optimum cluster is advantageous because the processing speed of the interpolation (including pixel readout and computation) depends on the size of the spot cluster. According to the above equation, for a spot at size of K×K pixels, the processing time is approximately proportional to K². The processing speed can be increased by using pixels for the calculation. An obvious option is to use only the one row of the pixels (row J) that are near the center of the spot and to employ an alternative 1D centroid algorithm, which is expressed as:

x_{c}≈x_{cl}=Σₗig_{y}/Σₗ g _{y}

Of course, the interpolation resolution will be reduced accordingly.

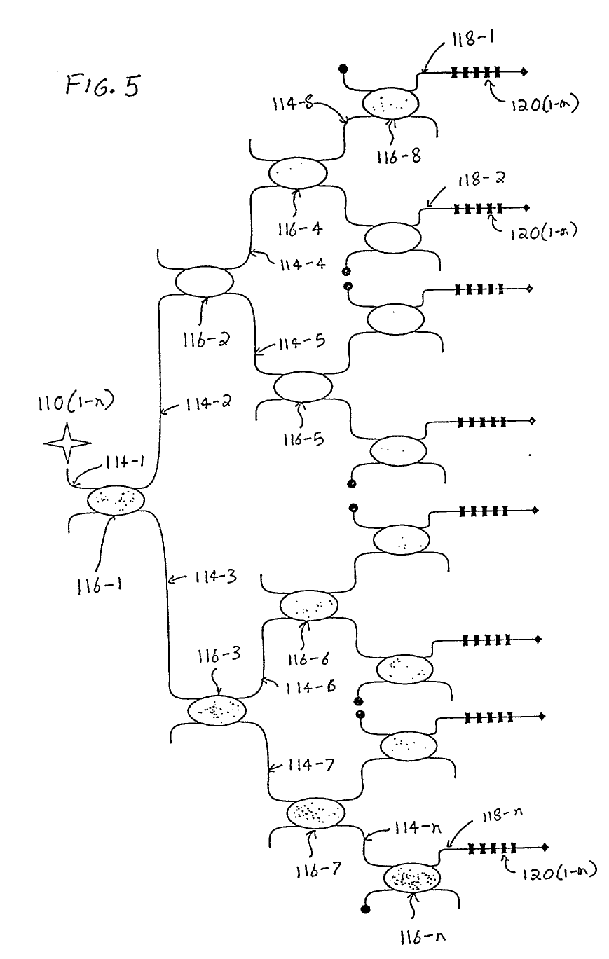

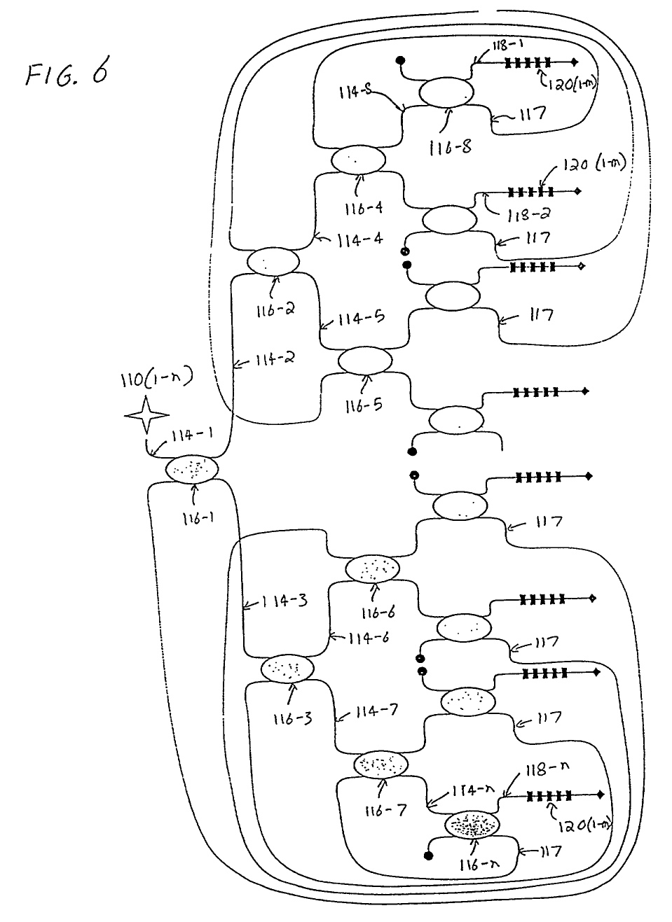

The centroid interpolation technique discussed above determines the centroid 38, which represents the weighted average of spot 25 over the pixels 30. FIG. 1D graphically shows centroid interpolation for FIG. 1C. As discussed above, since the precision of these algorithms depends on, amongst other factors, pixel noise, such noise must be taken into account for accurate centroid interpolation. Referring to FIGS. 34A-4C, such noise may be minimized by first determining a signal threshold value 195, below which all values are predominately noise. Next, threshold value 195 may be subtracted from all signal intensity values, and all negative signal intensity values set to zero. With all negative signal intensity values set to zero, the centroid 38 of the positive signal intensity values shown in FIG. 4C may be calculated as discussed above, by calculating the weighted average of all signal intensity values. This centroid interpolation technique minimizes the error for determining a centroid, as compared to the case where all signal intensity values below a certain threshold are simply set to zero, or where background noise is ignored. For example, if a signal intensity value is just above threshold value 195 and is predominately noise, this value, when used to calculate the weighted centroid 38 will significantly shift the calculated centroid value. The centroid interpolation technique described above may be utilized for both 1D and 2D fiber optic array setups.

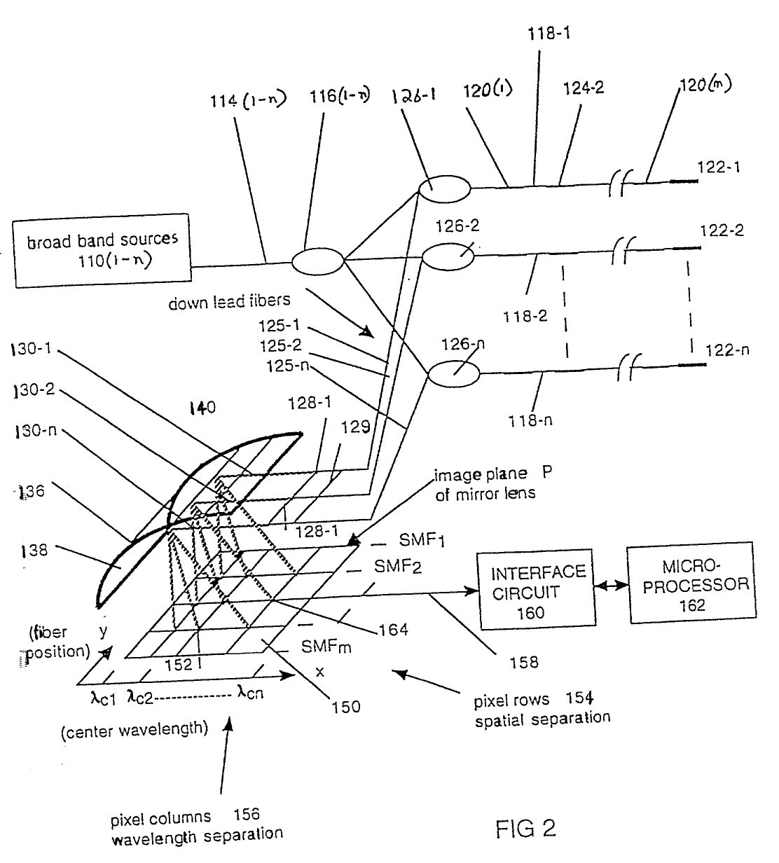

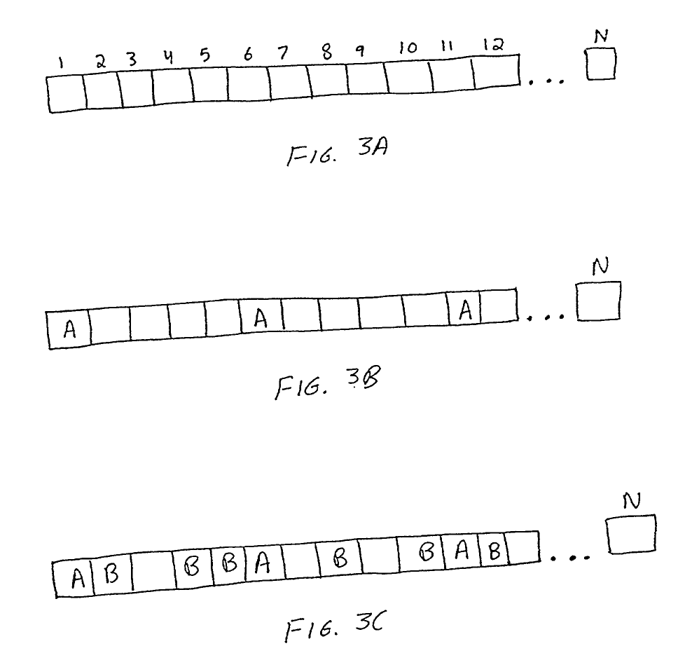

FIGS. 2, 5 and 6 illustrate in further detail an exemplary embodiment of a large scale, high speed optical fiber sensor network 100 in accordance with the present invention. The system may include multiple broad band light sources 110-1 . . . 110-n. The multiple broad band light sources 110-1 . . . 110-n provide greater bandwidth (wavelength), which enables more sensors per fiber, and higher intensity, which enables lower noise and higher resolution in the output signal. Multiple broad band light sources 110-1 . . . 110-n also allow for more fibers in a system, since the number of fibers is generally limited by the intensity of the broad band source. For example, if one single broadband light source has a bandwidth of 800-850 nm, this bandwidth limits the number of FBGs operable in the specified bandwidth. However, if a second broadband light source having a bandwidth of 850-900 nm is added to the system, FBGs operable in the bandwidth of the second source may be added to the fiber(s). Accordingly, with multiple broad band light sources 110-1 . . . 110-n, multiple FBGs may be added a single fiber or multiple fibers in a fiber sensor network.

For the system having multiple broad band light sources 110-1 . . . 110-n, light from each source 110-1 . . . 110-n may be coupled by respective lead fibers 114-1 . . . 114-n to couplers 116-1 . . . 116n. In the exemplary embodiment of FIG. 5, the light may be split to feed a plurality of 2×2 couplers 114-1 . . . 114-n. The light may then be further split to feed a plurality of single mode fibers 118-1 . . . 118-n, one for each channel. As shown in FIG. 6, light, which would be lost from the open coupler arms 117, may be fed back to the input arm of a previous coupler. This feed-back configuration allows maximum usage of light, which instead would be lost, thus providing more light for the system and attaining maximum usage of light from each broad band light source 110. Moreover, the feed-back configuration shown in FIG. 6 may be used with a single or multiple light sources to maximize utilization of light from each source or the single source. It should be understood that the exemplary embodiments of FIGS. 5 and 6 show a system for coupling multiple light sources 110-1 . . . 110-n to multiple fibers 118-1 . . . 118-n. Moreover, it should be understood that the embodiment of FIG. 2 shows a system for coupling multiple light sources 110-1 . . . 110-n to multiple fibers 118-1 . . . 118-n using the coupler illustrated in FIGS. 5 and 6, and couplers 126-1 . . . 126-n therebetween coupled to down-lead fibers 125-1 . . . 125-n.

Referring to FIG. 2, each fiber may have a plurality of FBGs 120-1 . . . 120-m, each with the predetermined different central wavelength λ1 . . . λm, respectively. In the arrangement illustrated, the end of each fiber may have a compensating temperature sensor 122-1 . . . 122-n. Light reflected by the FBGs in each channel may be coupled to down-lead fibers 125-1 . . . 125-n by a coupler 126-1 . . . 126-n in each channel. The free ends 128-1 . . . 128-n of the fibers 118 maybe arranged in a linear fiber bundle array 129 along line L, shown for example in FIG. 1A, in which the fibers in fiber array 12 are arranged side by side along line L. Output light 130-1 . . . 130-n from each corresponding fiber end may be directed at a dispersion unit 134 (i.e a spectrometer), which comprises a mirror lens 136 formed with a grooved grating 138 on the reflective surface as shown. Grooves 140 in the grating may be arranged parallel to the line L of the fiber end faces. The mirror 136 can form an image of the fiber array on an image plane P as shown. A solid state image sensor 150 (i.e. CMOS imager) comprising a j by k array of pixels 152 is disposed in the image plane P as shown. Pixel rows 154 correspond to the position of the channels established by fiber ends 128-1 . . . 128-n along the line L. Pixel columns 156 correspond to the number of fiber gratings FBG1 . . . FBGn in the corresponding wavelengths λ1-λn.

Sensor 150 may be positioned in such a way that the pixel columns 156 (y axis) are parallel to grooves 140 in grating 138 and to line L of fiber end faces 128-1 . . . 128-n. In addition, the surface of sensor 150 coincides with image plane P of mirror lens 136.

Sensor 150 has an output 158, which may be connected to an interface circuit 160 for processing by a microprocessor 162. It should be understood that the grating and lens is one of a variety of possible dispersion devices which may be employed.

In accordance with the invention, n fiber channels and m FBGs of different wavelengths along each fiber may form an n by m matrix of bright spots 164 on the array of sensor 150. Each column 156 in the matrix may represent the FBGs of the same or similar wavelength in different fiber channels, and each row may represent different FBGs along the same fiber. In other words, the spatial positions of the fiber channels may be encoded onto the position along the y axis of the detector while the wavelengths may be encoded along the x axis. The precise central wavelength of an FBG in a particular channel can therefore be detected by locating the exact position of the associated spot 164 along the x axis. The resolution of measurement depends upon the spatial resolution of the dispersion device and the detector array.

Evaluation of Reflected Signals (2D System)

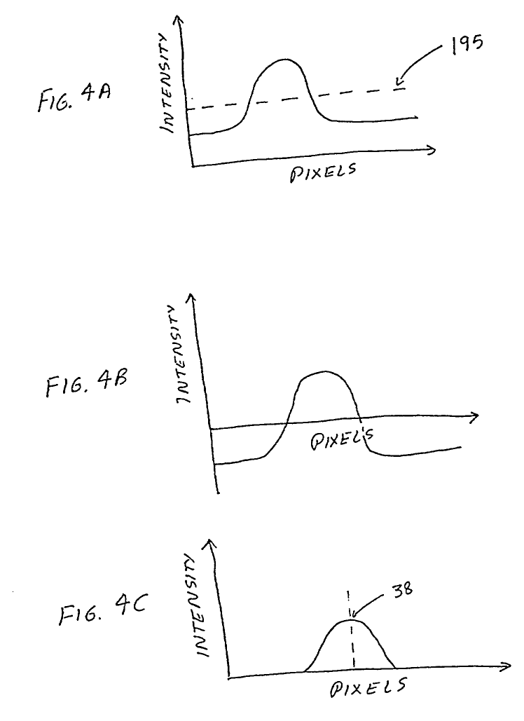

For the evaluation method described below, only the evaluation method for the embodiment of FIG. 2 will be described in detail (it should be readily understood that this method applies to the embodiment of FIG. 1 as well). In order to evaluate the light reflected by FBGs 120-1 . . . 120-m to down-lead fibers 125-1 . . . 125-n (for the embodiment of FIG. 2), or the light reflected by FBGs 16-1 . . . 16-m (for the embodiment of FIG. 1), fibers 118-1 . . . 118-n or fibers 14-1 . . . 14-n, respectively, may be evaluated by first ordering the fibers based upon their priority. For the embodiment of FIG. 2, this may be accomplished as shown in FIGS. 3A-3C by first assigning each fiber 118-1 . . . 118-n a priority. Next, as shown in FIG. 3A, the number of sampling slots N may be determined for sampling fibers 118-1 . . . 118-n in a predetermined time period. Thereafter, referring to FIGS. 3B and 3C, the fiber 118 of highest priority may be assigned a slot number for being sampled in a certain order. For example, fiber A (i.e. 118-1) having the highest priority may be sampled every fifth spot. Thereafter, fiber B (i.e. 118-2), having the second highest priority may be placed in the desired slot (i.e. every other spot for FIG. 3C). If the desired slot is taken, for example, by fiber A, fiber B may be placed in the closest slot. Specifically, if the desired slot is taken, then the slot one-back may be checked and fiber B may be placed in that slot. If the slot one-back is taken, then the next forward slot may be checked and fiber B may be placed in that slot. If the next forward slot is taken, then the slot two-back may be checked, and so forth. The microprocessor may be programmed to perform the above-identified checking/assigning steps for efficient evaluation of light reflected by FBGs 120-1 . . . 120-m in fibers 118-1 . . . 118-n.

One-Dimensional Fiber Optic Array Setup

A 1D fiber optic array setup according to the present invention will now be described in detail.

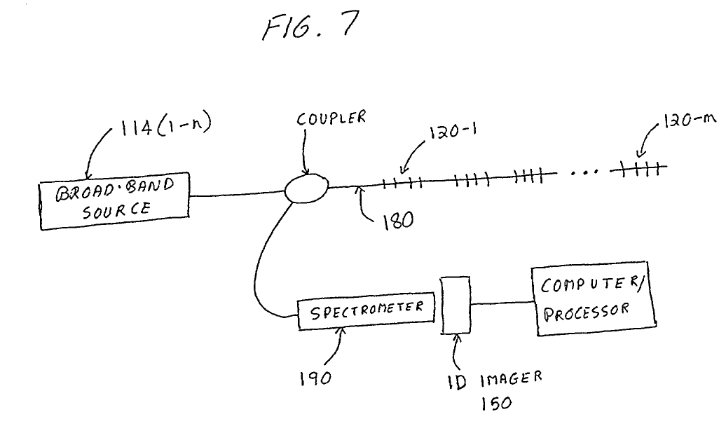

As shown in FIG. 7, a 1D fiber optic array setup may include a single fiber 180 having multiple FBGs 120. Light sent through one or more broadband sources 114-1 . . . 114-n down the fiber is reflected back by FBGs 120-1 . . . 120-m, sent to a dispersion device 190 (i.e. 1D spectrometer), then to a solid state image sensor 150 (i.e. 1D imager), and evaluated. As compared to the 2D fiber optic array setup described above and shown for example in FIGS. 1 and 2, the operation and processing of the reflected signals for the 1D system are faster. Additionally, for the 1D fiber optic array setup, the use of multiple broadband sources 114-1 . . . 114-n allows a greater bandwidth, thus more sensors per fiber. It should be understood that for the 1D fiber optic array setup of FIG. 7, each of the components may include the features described in detail above for the 2D fiber optic array setups shown in FIGS. 1 and 2. For the sake of redundancy, these components will not be described herein for the 1D fiber optic array.

Evaluation of Reflected Signals (1D System)

Referring to FIG. 7, in order to evaluate the light reflected by FBGs 120-1 . . . 120-m in fiber 180, FBGs 120-1 . . . 120-m may be evaluated by first ordering them based upon their priority. This may be accomplished in the manner discussed above for the ordering of fibers 118-1 . . . 128-n as, as shown in FIGS. 3A-3C by first assigning each FBG 120-1 . . . 120-m a priority. Next, as shown in FIG. 3A, the number of sampling slots N may be determined for sampling FBGs 120-1 . . . 120-m in a predetermined time period. Thereafter, referring to FIGS. 3B and 3C, the FBG 120 of highest priority may be assigned a slot number for being sampled in a certain order. For example, FBG A (i.e. 120-1) having the highest priority may be sampled every fifth spot. Thereafter, FBG B (i.e. 120-2), having the second highest priority may be placed in the desired slot (i.e. every other spot for FIG. 3C). If the desired slot is taken, for example, by FBG A, FBG B may be placed in the closest slot. Specifically, if the desired slot is taken, then the slot one-back may be checked and FBG B may be placed in that slot. If the slot one-back is taken, then the next forward slot may be checked and FBG B may be placed in that slot. If the next forward slot is taken, then the slot two-back may be checked, and so forth. The microprocessor may be programmed to perform the above-identified checking/assigning steps for efficient evaluation of light reflected by FBGs 120-1 . . . 120-m.

As previously stated, the centroid interpolation technique described above may also be utilized for the 1D fiber optic array setup described herein.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A method of sampling M sensors in a fiber optic system, said method comprising the steps of:
determining a maximum sampling rate possible, thereby defining N samples per time period;
assigning priority from X₁ to X_{M} for each sensor, such that a sensor of highest priority being assigned priority X₁ and a sensor of lowest priority being assigned priority X_{M};
dividing available sampling spots into discrete blocks, thereby defining N discrete blocks per said time period;
assigning at least one available sampling slot to a sensor Y(1) of said highest priority X₁, and placing said sensor Y(1) in said at least one available sampling slot;
assigning at least one other available sampling slot to sensors Y(2) to Y(M) of second priority X₂ to said lowest priority X_{M}, respectively;
placing said sensor Y(2) in a closest available sampling slot if said sampling slot for said sensor Y(2) is filled;
repeating said placing step in order from sensor Y(3) to said sensor Y(M) until all sampling slots are filled; and
sampling said M sensors in order of said assigned sampling slots.

2. A method according to claim 1, wherein said closest available slot is a slot one-back of said filled spot, if said closest available slot is taken, said closest available slot is a slot one-forward of said filled spot such that said closest available slot is determined by toggling back and forth in increasing steps until a closest available slot is free, said closest available slot being said free slot.

3. A method according to claim 1, wherein said time period is seconds.

4. A method according to claim 1, wherein said sensor is a fiber.

5. A method according to claim 4, wherein said fiber includes at least one fiber Bragg grating.

6. A method according to claim 1, wherein said sensor is a fiber Bragg grating.

7. A digital spatial and wavelength domain system for multiplexing fiber Bragg grating (FBG) sensors, said system comprising:
a plurality of optical fibers, each including a plurality of fiber Bragg gratings (FBG) therein, each FBG having selective center wavelength being variable in accordance with strain for reflecting or transmitting light at the corresponding center wavelength in accordance with the strain thereat;
at least one broad band light illumination source for the FBGs, each said source coupled to said FBGs by a plurality of 2×2 couplers;
means for each optical fiber for carrying the light to a selected location;
a wavelength dispersion device responsive to the light from each of the fibers for wavelength separating the light in each said fiber into the center wavelengths in accordance with the location of each fiber so that the selected location of each fiber and the wavelength separated light provides spatially independent signals for each FBG in each optical fiber.

8. A system according to claim 7, wherein each said 2×2 coupler includes first and second input arms and first and second output arms,
said first input arm of a 2×2 coupler one of connected to said at least one source, one of first and second output arms of another 2×2 coupler, and blocked,
said second input arm of said 2×2 coupler one of connected to another said at least one source, one of said first and second output arms of another 2×2 coupler, and blocked,
said first output arm of said 2×2 coupler connected to one of an input arm of another 2×2 coupler, and an optical fiber,
said second output arm of said 2×2 coupler one of connected to an input arm of another 2×2 coupler, and an optical fiber,
whereby said plurality of 2×2 couplers permit maximum usage of light from said at least one source by feeding back light from an open output arm of a 2×2 coupler to an open input arm of a 2×2 coupler.

9. A digital and spatial wavelength domain system comprising:
a plurality of optical fibers, each including a plurality of fiber Bragg gratings (FBGs), each having a center wavelength;
at least one broad band light source for illuminating each FBG, each said source coupled to said FBGs by a plurality of 2×2 couplers;
each of said FBGs being operative for reflecting a portion of the light at the center wavelength corresponding thereto in accordance with a stress applied to said fiber thereat;
a wavelength dispersion device operatively coupled to each fiber and responsive to the light for separating the light in each said fiber into a sensible signal at the corresponding wavelength for each FBG; and
optically sensitive solid state means spatially responsive to the sensible signal for producing an output for spatially separating the signals at each wavelength.

10. A system according to claim 9, wherein each said 2×2 coupler includes first and second input arms and first and second output arms,
said first input arm of a 2×2 coupler one of connected to said at least one source, one of first and second output arms of another 2×2 coupler, and blocked,
said second input arm of said 2×2 coupler one of connected to another said at least one source, one of said first and second output arms of another 2×2 coupler, and blocked,
said first output arm of said 2×2 coupler connected to one of an input arm of another 2×2 coupler, and an optical fiber,
said second output arm of said 2×2 coupler one of connected to an input arm of another 2×2 coupler, and an optical fiber,
whereby said plurality of 2×2 couplers permit maximum usage of light from said at least one source by feeding back light from an open output arm of a 2×2 coupler to an open input arm of a 2×2 coupler.

11. A system according to claim 9, wherein the wavelength dispersion device comprises a bulk grating.

12. A system according to claim 11, wherein the grating comprises a mirror lens having a focal plane and a grating disposed on a reflective surface thereof.

13. A system according to claim 12, wherein the grating includes parallel grooves formed in the reflective surface.

14. A system according to claim 9, further comprising fiber means for carrying the light from the fiber to said wavelength dispersion device, said fiber means having output ends aligned in a linear array.

15. A system according to claim 9, wherein the optically sensitive means comprises a solid state sensing device including a plurality of pixels arranged in a two dimensional array.

16. A system according to claim 15, wherein the pixels are randomly accessible.

17. A system according to claim 9, wherein the imaging device includes a 2D array of pixels and wherein the wavelength separated light impinges on the array at selected pixel locations.

18. A system according to claim 17, wherein the light from the impinging light forms a spot on the imaging device covering a plurality of pixels and further including processing means for sensing the light in each of said pixels and weight averaging the light for determining a centroid of said spot corresponding to the center wavelength thereof.

19. A system according to claim 9, comprising at least one strain independent sensor means for each fiber for providing a temperature calibration signal at a selected center wavelength.

20. A system according to claim 19, wherein the strain independent sensor means is disposed at the free end of the fiber remote from the source.

21. A system according to claim 19, wherein the strain independent sensor means is within the fiber.

22. A system according to claim 9, further comprising means for at least one of detecting the center wavelength for each wavelength separated signal in accordance with at least one of centroid weighting; curve fitting; and
linear and higher order interpolation.

23. A system according to claim 9, further comprising means for carrying the light to the wavelength dispersion device.

24. A system according to claim 23, wherein the means comprises a down-lead fiber for each optical fiber.

25. A system according to claim 24, wherein the means comprises a free end of the optical fibers.

26. A system according to claim 9, further comprising means for distributing the light to each optical fiber.

27. A system according to claim 18, wherein said centroid is determined by:
a circuit for determining intensity values of said signal over a range of sensed wavelengths;
a circuit for subtracting a threshold value from said intensity values, thereby defining negative and positive intensity values;
a circuit for setting said negative intensity values to zero; and
a circuit for interpolating said centroid by taking a weighted average of said positive intensity values.

28. A method of determining said centroid in the system of claim 18, said method comprising the steps of:
determining intensity values of said signal over a range of sensed wavelengths;
subtracting a threshold value from said intensity values, thereby defining negative and positive intensity values;
setting said negative intensity values to zero; and
interpolating said centroid by taking a weighted average of said positive intensity values.

29. A digital and spatial wavelength domain system comprising:
a single optical fiber including a plurality of fiber Bragg gratings (FBGs), each having a center wavelength;
at least one broad band light sources for illuminating each FBG;
each of said FBGs being operative for reflecting a portion of the light at the center wavelength corresponding thereto in accordance with a stress applied to said fiber thereat;
a wavelength dispersion device operatively coupled to said fiber and responsive to the light for separating the light in said fiber into a sensible signal at the corresponding wavelength for each FBG; and
optically sensitive solid state means spatially responsive to the sensible signal for producing an output for spatially separating the signals at each wavelength.

30. A system according to claim 29, wherein the wavelength dispersion device is a one-dimensional device and comprises a bulk grating.

31. A system according to claim 30, wherein the grating comprises a mirror lens having a focal plane and a grating disposed on a reflective surface thereof.

32. A system according to claim 31, wherein the grating includes parallel grooves formed in the reflective surface.

33. A system according to claim 29, further comprising fiber means for carrying the light from the fiber to said wavelength dispersion device, said fiber means having output ends aligned in a linear array.

34. A system according to claim 29, wherein the optically sensitive means comprises a one-dimensional solid state sensing device including a plurality of pixels arranged in a one dimensional array.

35. A system according to claim 34, wherein the pixels are randomly accessible.

36. A system according to claim 29, wherein the imaging device includes a 1D array of pixels and wherein the wavelength separated light impinges on the array at selected pixel locations.

37. A system according to claim 36, wherein the light from the impinging light forms a spot on the imaging device covering a plurality of pixels and further including processing means for sensing the light in each of said pixels and weight averaging the light for determining a centroid of said spot corresponding to the center wavelength thereof.

38. A system according to claim 29, comprising at least one strain independent sensor means for said fiber for providing a temperature calibration signal at a selected center wavelength.

39. A system according to claim 38, wherein the strain independent sensor means is disposed at the free end of the fiber remote from the source.

40. A system according to claim 38, wherein the strain independent sensor means is within the fiber.

41. A system according to claim 29, further comprising means for at least one of detecting the center wavelength for each wavelength separated signal in accordance with at least one of centroid weighting; curve fitting; and
linear and higher order interpolation.

42. A system according to claim 29, further comprising means for carrying the light to the wavelength dispersion device.

43. A system according to claim 42, wherein the means comprises a down-lead fiber for said optical fiber.

44. A system according to claim 43, wherein the means comprises a free end of the optical fiber.

45. A system according to claim 29, further comprising means for distributing the light to said optical fiber.

46. A system according to claim 37, wherein said centroid is determined by:
a circuit for determining intensity values of said signal over a range of sensed wavelengths;
a circuit for subtracting a threshold value from said intensity values, thereby defining negative and positive intensity values;
a circuit for setting said negative intensity values to zero; and
a circuit for interpolating said centroid by taking a weighted average of said positive intensity values.
